(19) United States
(12) Patent Application Publication
(10) Pub. No.: US 2015/0012115 A1
(43) Pub. Date: Jan. 8, 2015

(54) OPERATING ENVIRONMENT PARAMETER REGULATION IN A MULTI-PROCESSOR ENVIRONMENT

(71) Applicant: NVIDIA Corporation, Santa Clara, CA (US)

(72) Inventors: Abdeali H. Panvelwala, Pune (IN); Sasaank Botlaguduru, Pune (IN)

(21) Appl. No.: 13/935,489

(22) Filed: Jul. 4, 2013

(51) Int. Cl. G05D 23/19

(52) U.S. Cl. CPC G05D 23/19
USPC 700/7; 700/300

(57) ABSTRACT

A method includes receiving, at a control server, data related to a parameter of an operating environment of a number of processors. Each processor is associated with a data processing device of a number of data processing devices. The method also includes transmitting, through a processor of the control server, one or more control signal(s) to one or more logic controller(s) based on analysis of the parameter through the processor of the control server and/or the number of processors. The analysis includes comparison of the parameter with one or more reference threshold(s). Further, the method includes maintaining, through one or more regulation system(s), the parameter of the operating environment of one or more processor(s) of the number of processors around the one or more reference threshold(s) in accordance with the one or more control signal(s) transmitted to the one or more logic controller(s).

### FIELD OF TECHNOLOGY

This disclosure relates generally to multi-processor environment(s) and, more particularly, to operating environment parameter regulation in a multi-processor environment.

### BACKGROUND

A computing system (e.g., a computer cluster) may include a number of data processing devices (e.g., a server, a desktop computer, a laptop computer) therein. Each data processing device may include a processor communicatively coupled to a memory; the processor may have an optimal level of a parameter (e.g., temperature) of an operating environment thereof for which performance thereof is reliable. Excess level of a parameter such as temperature, may cause the processors to overheat, resulting in unreliability of operation thereof. The operating temperature(s) may be controlled based on regulating temperature of an external operating environment through a cooling system (e.g., an air-conditioner). Even if the cooling system were to be employed to regulate the temperature, operating temperature(s) of one or more individual processor(s) may have already crossed the optimal level. Thus, the reliability of the processing environment provided by the computing system may still be compromised.

### SUMMARY

Disclosed are a method, a device and/or a system of operating environment parameter regulation in a multi-processor environment.

In one aspect, a method includes receiving, at a control server, data related to a parameter of an operating environment of a number of processors. Each processor of the number of processors is associated with a data processing device of a number of data processing devices. The control server is communicatively coupled to the number of data processing devices. The method also includes transmitting, through a processor of the control server, one or more control signal(s) to one or more logic controller(s) based on analysis of the parameter through the processor of the control server and/or the number of processors. The analysis includes comparison of the parameter with one or more reference threshold(s).

Further, the method includes maintaining, through one or more regulation system(s) communicatively coupled to the one or more logic controller(s), the parameter of the operating environment of one or more processor(s) of the number of processors around the one or more reference threshold(s) in accordance with the one or more control signal(s) transmitted to the one or more logic controller(s).

In another aspect, a control server includes a memory, and a processor communicatively coupled to the memory. The processor is configured to receive data related to a parameter of an operating environment of a number of processors. Each processor of the number of processors is associated with a data processing device of a number of data processing devices. The control server is communicatively coupled to the number of data processing devices. Based on the reception of the data related to the parameter, the processor is further configured to execute instructions to transmit one or more control signal(s) to one or more logic controller(s) based on comparison of the parameter with one or more reference threshold(s) thereat and/or through the number of processors to enable one or more regulation system(s) communicatively coupled to the one or more logic controller(s) maintain the parameter of the operating environment of one or more processor(s) of the number of processors around the one or more reference threshold(s) in accordance with the one or more control signal(s).

In yet another aspect, a system includes a number of data processing devices, with each data processing device including a processor. The system also includes one or more logic controller(s) and a control server communicatively coupled to the number of data processing devices. The control server is configured to receive data related to a parameter of an operating environment of the number of processors, and to transmit one or more control signal(s) to the one or more logic controller(s) based on analysis of the parameter through the control server and/or the number of processors. The analysis includes comparison of the parameter with one or more reference threshold(s).

Further, the system includes one or more regulation system(s) communicatively coupled to the one or more logic controller(s) to maintain the parameter of the operating environment of one or more processor(s) of the number of processors around the one or more reference threshold(s) in accordance with the one or more control signal(s) transmitted to the one or more logic controller(s).

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a computing system, according to one or more embodiments

FIG. 2 is a schematic view of a computing system where temperature regulation is localized to actively operating processors, according to one or more embodiments.

FIG. 3 is a schematic view of a computing system with an internal cooling system associated with each processor thereof, according to one or more embodiments.

FIG. 4 is a schematic view of a computing system with a logic controller associated with an internal cooling system of each processor thereof, according to one or more embodiments.

FIG. 5 is a schematic view of a computing system with temperature comparison(s) being performed through processors thereof, according to one or more embodiments.

FIG. 6 is a schematic view of interaction between a driver component and a processor of a control server of the computing system(s) of FIGS. 1-5, processor(s) of a number of data processing device(s) of the computing system(s) of FIGS. 1-5 and/or temperature sensor(s) of the computing system of FIG. 1 (and, analogously, FIGS. 2-5), according to one or more embodiments.

FIG. 7 is a process flow diagram detailing the operations involved in operating environment parameter regulation in a multi-processor environment, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of operating environment parameter regulation in a multi-processor environment. Although the present embodiments have been described with reference to specific example embodiments, it will be evident that various modifications and changes may be made to these embodiments without departing from the broader spirit and scope of the various embodiments.

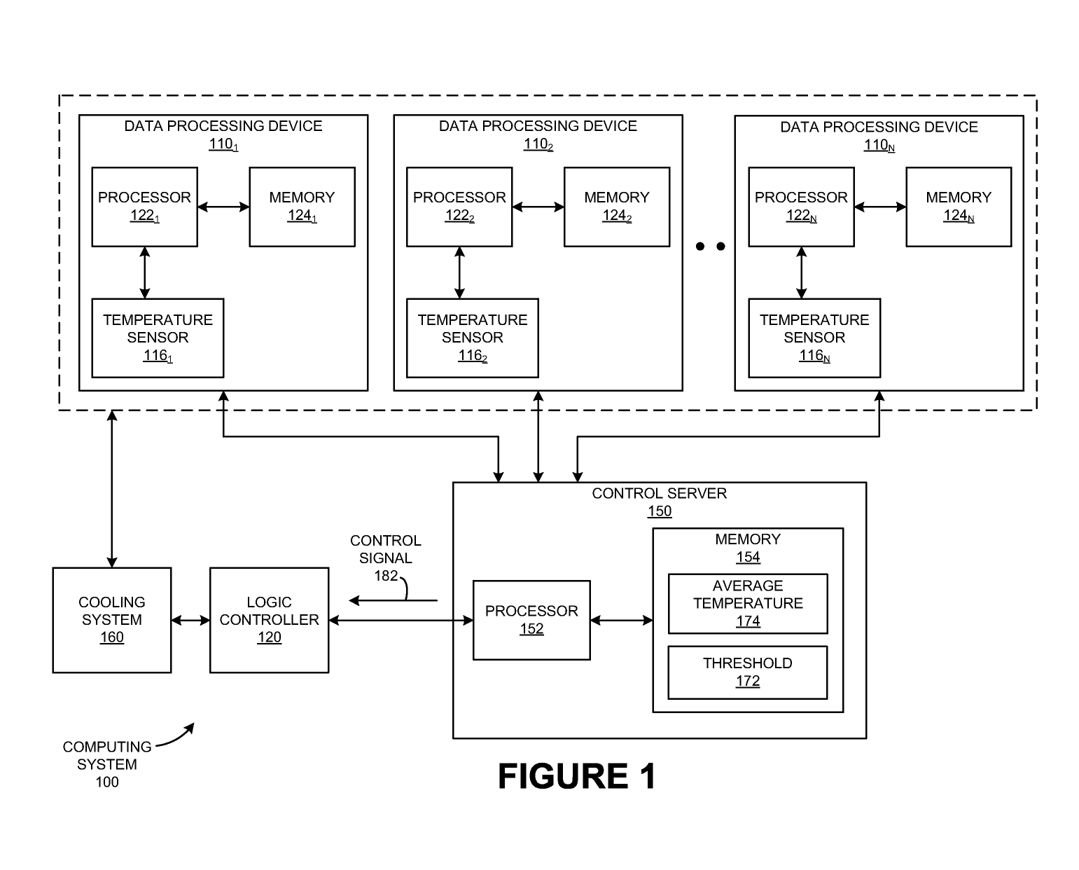

FIG. 1 shows a computing system 100, according to one or more embodiments. In one or more embodiments, computing system 100 may include a number of data processing devices 110_{1-N}, each of which includes a processor 122_{1-N} (e.g., a Central Processing Unit (CPU), a Graphics Processing Unit (GPU)) communicatively coupled to a memory 124_{1-N} (e.g., a volatile memory and/or a non-volatile memory); memory 124_{1-N} may include storage locations addressable through processor 122_{1-N}. It should be noted that a processor 122_{1-N}, in turn, may include a number of processors/microcontrollers therein. In one or more embodiments, each data processing device 110_{1-N} may be a server, desktop computer, a laptop computer, a notebook computer, a netbook etc. Other forms of data processing devices 110_{1-N} are within the scope of the exemplary embodiments discussed herein.

In one example embodiment, computing system 100 may be associated with a data center; also, computing system 100 may be a cluster computing system, in which each data processing device 110_{1-N} is a node. In one or more embodiments, the each data processing device 110_{1-N} may have one or more sensor(s) (e.g., temperature sensor 116_{1-N}) associated therewith configured to sense data related to an external environment in which a corresponding processor 122_{1-N} is operating. Although exemplary embodiments have been preferentially discussed within the context of remote monitoring and control of operating temperature(s) of processor(s) 122_{1-N}, it should be noted that monitoring and control of other parameters such as humidity are also within the scope thereof.

In one or more embodiments, computing system 100 may have an external cooling system 160 (e.g., liquid air cooling system, air-conditioner in a room in which data processing devices 110_{1-N} are located) associated therewith. In one or more embodiments, external cooling system 160 may be common to all data processing devices 110_{1-N}; external cooling system 160 may serve to maintain operating temperature(s) of processors 122_{1-N} around an optimal threshold temperature limit (e.g., 25 degrees Celsius). In one or more embodiments, computing system 100 may have a control server 150 associated therewith; control server 150 may have a processor 152 communicatively coupled to a memory 154.

In one or more embodiments, the temperatures sensed through temperature sensors 116_{1-N} may be received at control server 150; control server 150 may be configured to have the threshold temperature limit (e.g., threshold 172) stored in memory 154. It should be noted that threshold 172 may vary between processor(s) 122_{1-N} or be the same. For example, one processor 122_{1-N} may be more robust with regard to an increased operating temperature than another processor 122_{1-N}; therefore, the aforementioned processor(s) 122_{1-N} may have different values of threshold 172 associated therewith. In one or more embodiments, upon receipt of the temperatures sensed through temperature sensors 116_{1-N}, processor 152 of control server 150 may be configured to analyze said temperatures to determine whether cooling system 160 requires temperature control. For example, processor 152 may be configured to average the temperatures (e.g., average temperature 174 is shown as being stored in memory 154) sensed, and then compare average temperature 174 with threshold 172.

In one or more embodiments, based on the abovementioned comparison, processor 152 may be configured to transmit a control signal 182 to a logic controller 120 (e.g., a Programmable Logic Controller (PLC); logic controller 120 may be part of control server 150 or distinct from control server 150) associated therewith to prevent rising of the operating temperature(s) of processor(s) 122_{1-N} above threshold 172 through cooling system 160. In one or more embodiments, logic controller 120 may be programmed to enable cooling system 160 regulate the operating temperature(s) of processors 122_{1-N} around threshold 172 upon receipt of control signal 182. In one or more embodiments, control signal 182 may also carry information associated with an extent of temperature regulation required.

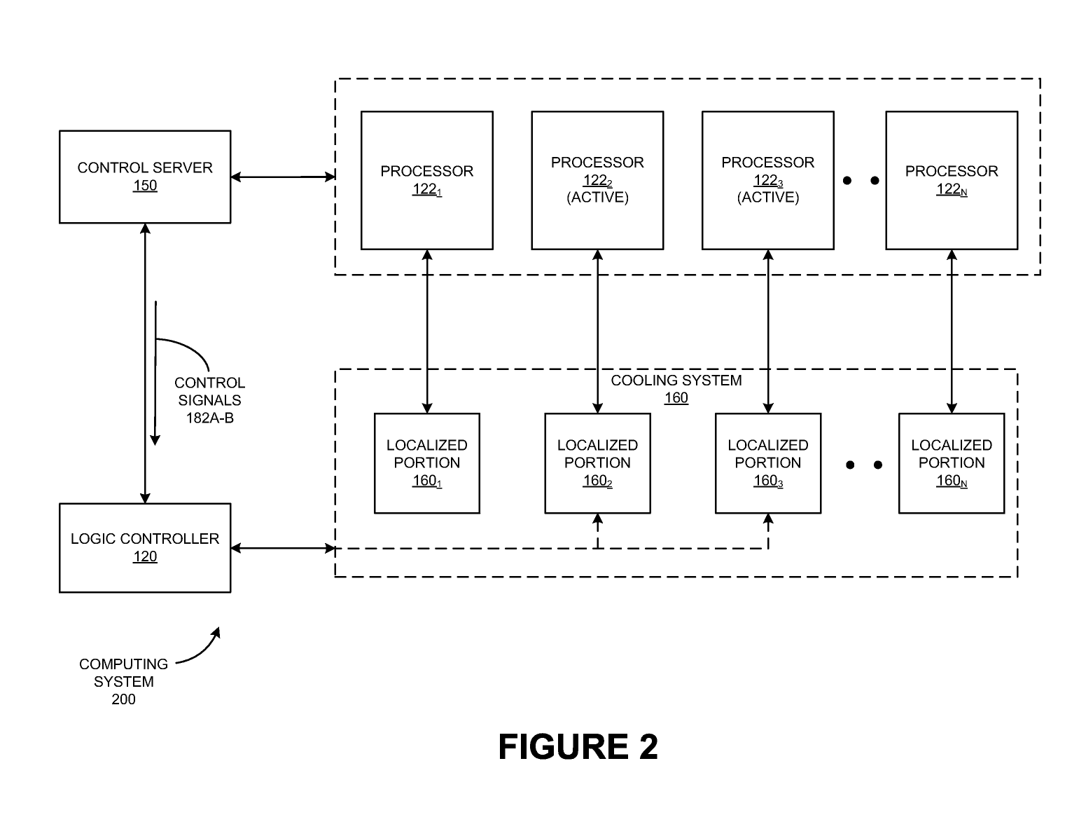

In one or more alternate embodiments, processor 152 of control server 150 may be configured to receive the sensed temperature(s) and determine one or more processor(s) 122_{1-N} that require cooling based on the received temperature(s). For example, in a cluster of 60 computers, only 25 may be actively operating as evidenced by the operating temperatures of processor(s) 122_{1-N} thereof received at control server 150. Here, processor 152 may be configured to transmit control signal(s) (e.g., control signal 182) to logic controller 120 to enable cooling system 160 regulate the operating temperature(s) of the one or more active processor(s) 122_{1-N}. FIG. 2 shows a computing system 200 in which temperature regulation may be localized to actively operating processor(s) 122_{1-N}, according to one or more alternate embodiments.

Here, cooling system 160 may include localized portion(s) 160_{1-N} associated with processor(s) 122_{1-N}. The control signal(s) 182A-B received at logic controller 120 through control server 150 may trigger localization of the temperature regulation through cooling system 160 (e.g., by modifying appropriate relays/control circuits of logic controller 120 to modify voltage levels associated with localized portion 160₂ and 160₃ shown in FIG. 2). For example, cooling system 160 may house data processing device(s) 110_{1-N} in a room; each localized portion 160_{1-N} may be associated with cooling an individual processor 122_{1-N} of a data processing device 110_{1-N}.

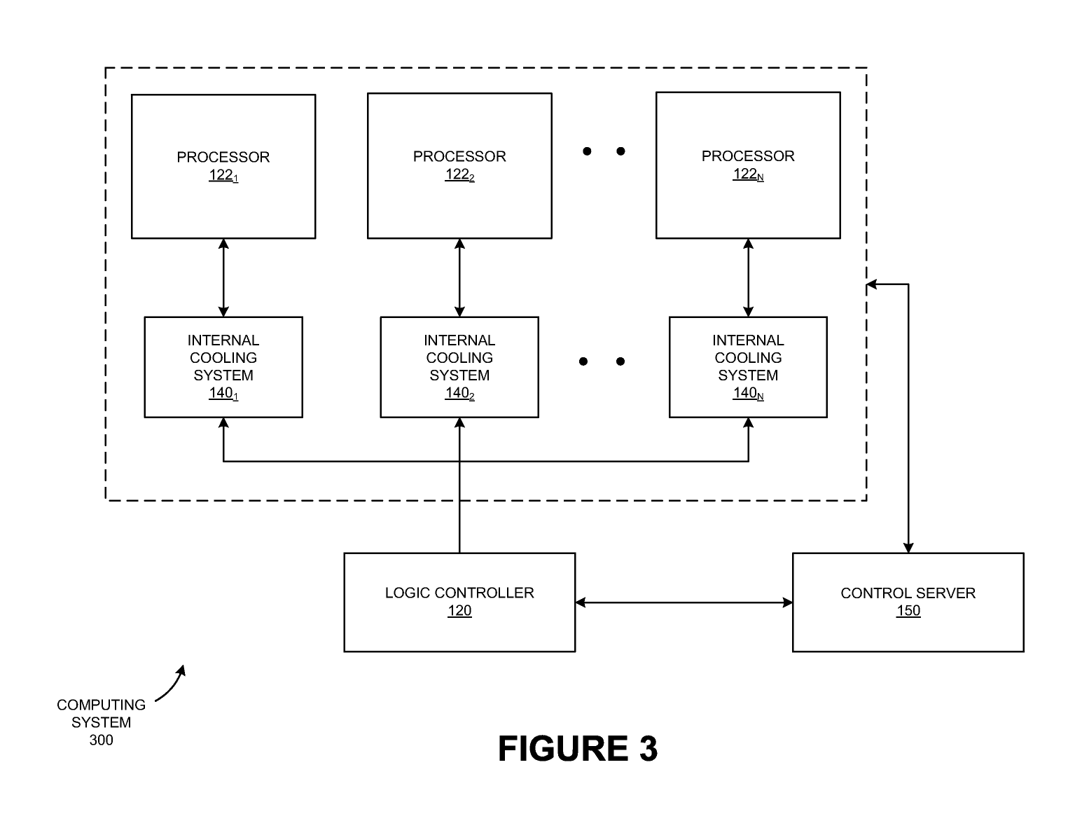

FIG. 3 shows a computing system 300 with an internal cooling system 140_{1-N} associated with each processor 122_{1-N}, according to one or more alternate embodiments. Here, control signal 182/control signals 182A-B may enable logic controller 120 trigger regulation of operating temperature(s) of processor(s) 122_{1-N} through internal cooling system(s) 140_{1-N} (e.g., by modifying processor fan speed, by modifying an amount of cooling liquid delivered to pipes associated with internal cooling system 140_{1-N}).

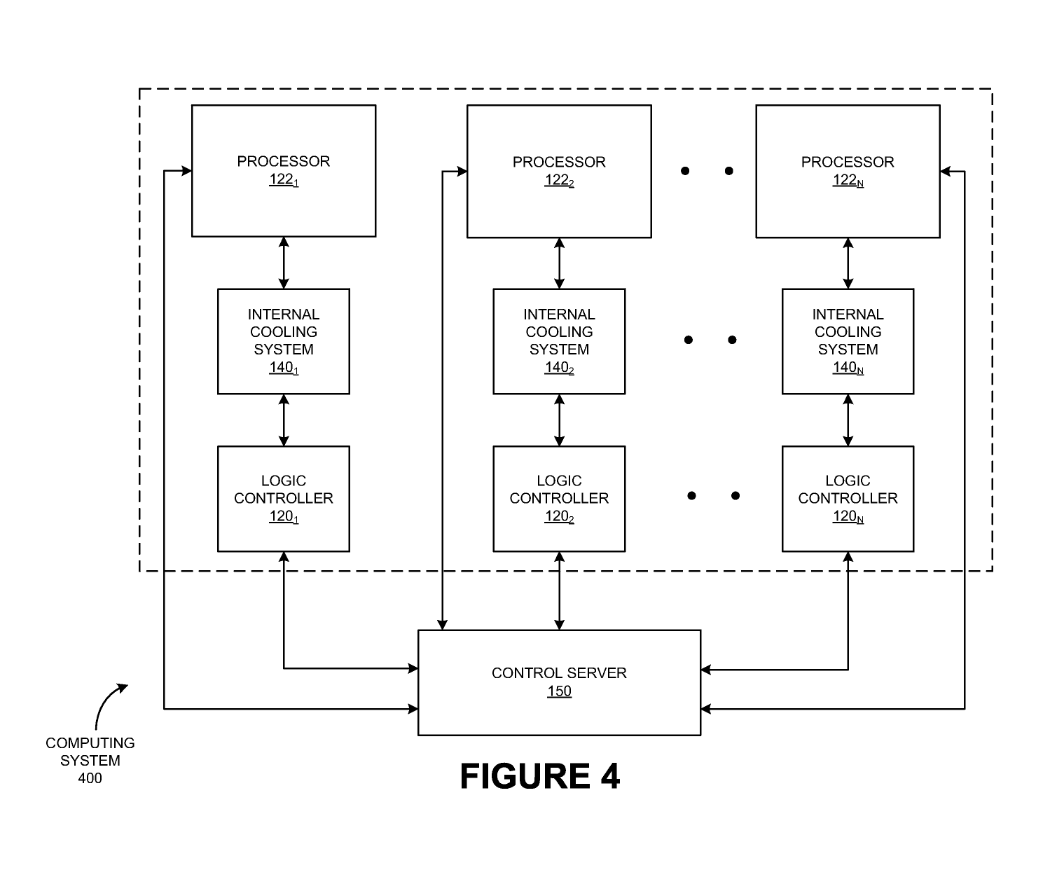

FIG. 4 shows computing system 400 with a logic controller 120_{1-N} associated with internal cooling system 140_{1-N} of each processor 122_{1-N}, according to one or more alternate embodiments. Here, the control signals transmitted from control server 150 may enable logic controller 120_{1-N} trigger the regulation of the operating temperature(s) of processor(s) 122_{1-N} through internal cooling system(s) 140_{1-N}. It is obvious that logic controller 120_{1-N} may instead be external to data processing device 110_{1-N} including processor 122_{1-N}.

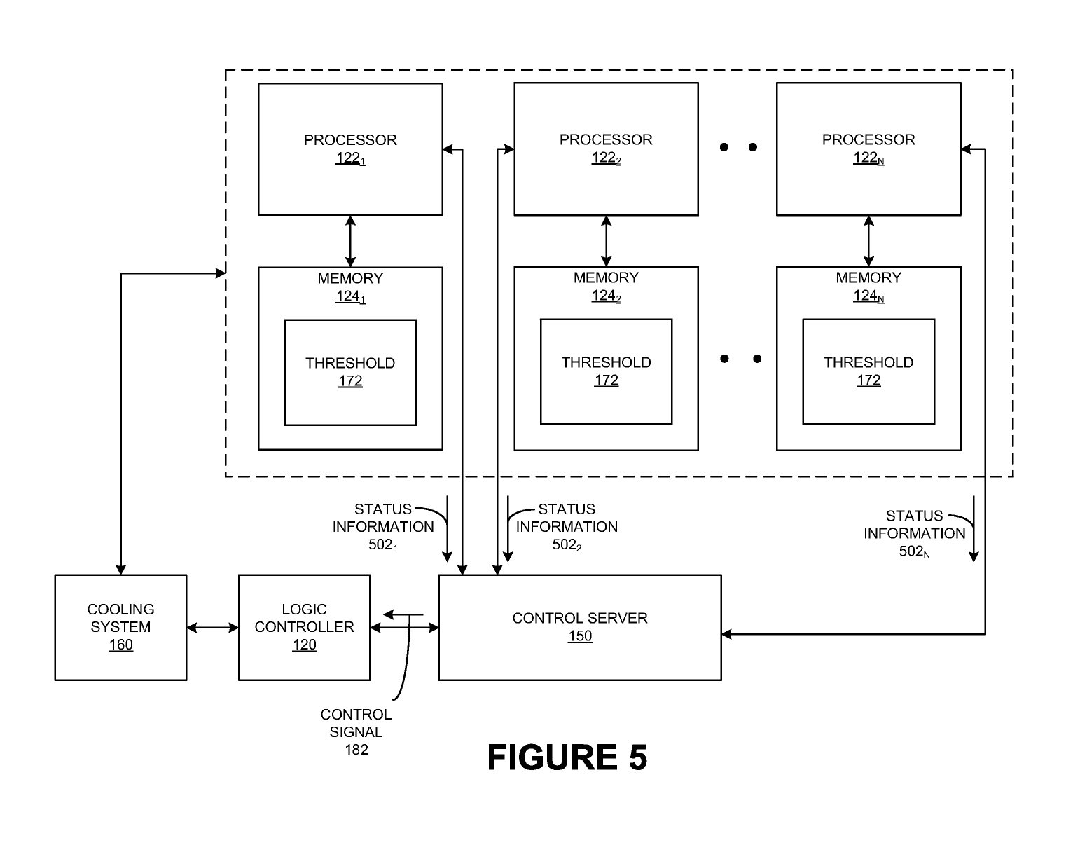

It should be noted that the threshold comparison discussed above may be performed at processor 122_{1-N} instead of processor 152. Here, processor 122_{1-N} may transmit status information thereof to control server 150. The status information may indicate to control server 150 that the corresponding processor 122_{1-N} requires operating temperature control. Based on the receipt of the status information, control server 150 may transmit control signal 182 to logic controller 120/120_{1-N} to trigger the regulation of the operating temperature of processor 122_{1-N} through the appropriate internal cooling system 140_{1-N}/localized portion 160_{1-N}. FIG. 5 shows the local threshold comparison through processor(s) 122_{1-N}, according to one or more alternate embodiments. Here, threshold 172 may be stored in memory 124_{1-N}.

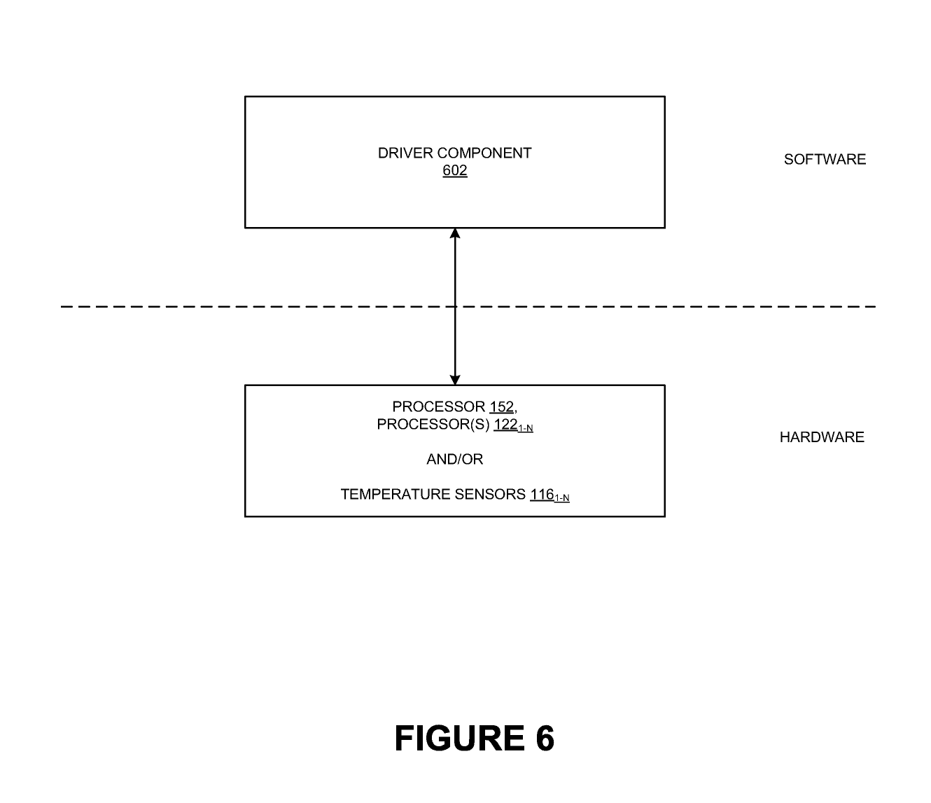

In one or more embodiments, the receipt of the temperature(s) at control server 150 and/or status information (e.g., status information 502_{1-N}) of processor(s) 122_{1-N} discussed above may be periodic or continuous. In one or more embodiments, threshold 172 (threshold 172 may include one or more threshold values) discussed above may be pre-determined and stored in memory 154/124_{1-N}. In one or more embodiments, threshold 172 may be dynamically determined through control server 150 based on executing an appropriate algorithm therefore on processor 152. Alternately, threshold 172 may be made available through a driver component (e.g., a set of instructions) associated with processor 152, processor(s) 122_{1-N} and/or temperature sensor(s) 116_{1-N}. FIG. 6 shows interaction between a driver component 602 and processor 152, processor(s) 122_{1-N} and/or temperature sensor(s) 116_{1-N}, according to one or more embodiments.

In one or more embodiments, driver component 602 may be loaded onto control server 150 and/or data processing device 110_{1-N} upon booting thereof. In one or more embodiments, driver component 602 may be configured to initiate the abovementioned temperature sensing, temperature data reception and/or the transmission of the control signal(s) as one or more foreground processes or background processes. In one or more embodiments, driver component 602 may be packaged with an operating system (not shown) executing on control server 150 and/or data processing device 110_{1-N}, and/or an application (not shown) executing thereon. In one or more embodiments, control server 150 may be communicatively coupled to data processing devices 110_{1-N} through wired and/or wireless (e.g., Internet, Wide Area Network (WAN), Bluetooth®, Wi-Fi®) means. All reasonable modifications are within the scope of the exemplary embodiments discussed herein.

As discussed above, cooling system 160 may not always be related to direct regulation of operating temperature(s) of processor(s) 122_{1-N}. For example, cooling system 160 may be one or more air-conditioning unit(s) located in a room in which data processing device(s) 110_{1-N} are also housed. Again, regulation of other parameter(s) (e.g., cooling system 160 may be generalized to a regulation system) associated with the external operating environment of processor(s) 122_{1-N} such as humidity are within the scope of the exemplary embodiments discussed herein. Logic controller 120, temperature sensor(s) 116_{1-N} and other relevant sensor(s) such as humidity sensor(s) are well known to one skilled in the art; detailed discussion associated therewith has been skipped for the sake of clarity and brevity. Further, implementations such as a temperature sensor 116_{1-N} and a humidity sensor being provided on a same hardware block of a data processing device 110_{1-N} are also within the scope of the exemplary embodiments discussed herein.

To summarize, exemplary embodiments provide a means to regulate operating environment parameter(s) (e.g., temperature) of processor(s) 122_{1-N} around threshold 172 without a need for the aforementioned parameter(s) to exceed threshold 172. This may ensure continued reliable operation of processor(s) 122_{1-N}. Further, the localization of the regulation may save power associated with utilization of all localized portion(s) 160_{1-N} of cooling system 160; now, only the requisite localized portion(s) 160_{1-N} may need to be utilized.

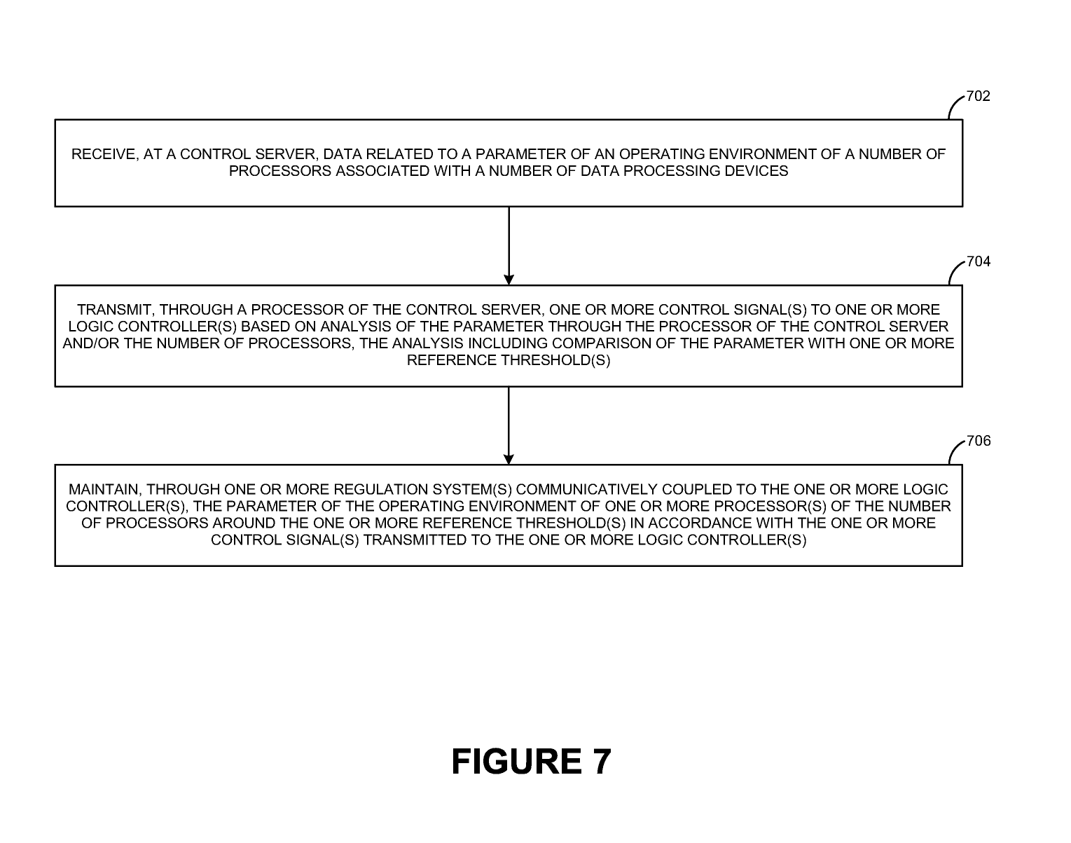

FIG. 7 shows a process flow diagram detailing the operations involved in operating environment parameter regulation in a multi-processor environment, according to one or more embodiments. In one or more embodiments, operation 702 may involve receiving, at control server 150, data related to a parameter of an operating environment of a number of processors 122_{1-N}. In one or more embodiments, each processor 122_{1-N} of the number of processors 122_{1-N} may be associated with a data processing device 110_{1-N} of a number of data processing devices 110_{1-N}. In one or more embodiments, control server 150 may be communicatively coupled to the number of data processing devices 110_{1-N}.

In one or more embodiments, operation 704 may involve transmitting, through a processor 152 of control server 150, one or more control signal(s) (e.g., control signal 182) to one or more logic controller(s) (e.g., logic controller 120) based on analysis of the parameter through processor 152 and/or the number of processors 122_{1-N}. In one or more embodiments, the analysis may include comparison of the parameter with one or more reference threshold(s) (e.g., threshold 172). In one or more embodiments, operation 706 may then involve maintaining, through one or more regulation system(s) (e.g., cooling system 160) communicatively coupled to the one or more logic controller(s), the parameter of the operating environment of one or more processor(s) 122_{1-N} of the number of processors 122_{1-N} around the one or more reference threshold(s) in accordance with the one or more control signal(s) transmitted to the one or more logic controller(s).

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., control server 150, data processing device(s) 110_{1-N}). Accordingly, the specification and drawings are to be regarded in an illustrative rather than a restrictive sense.

What is claimed is:

1. A method comprising:
receiving, at a control server, data related to a parameter of an operating environment of a plurality of processors, each processor of the plurality of processors being associated with a data processing device of a plurality of data processing devices, and the control server being communicatively coupled to the plurality of data processing devices;
transmitting, through a processor of the control server, at least one control signal to at least one logic controller based on analysis of the parameter through at least one of: the processor of the control server and the plurality of processors, the analysis including comparison of the parameter with at least one reference threshold; and
maintaining, through at least one regulation system communicatively coupled to the at least one logic controller, the parameter of the operating environment of at least one processor of the plurality of processors around the at least one reference threshold in accordance with the at least one control signal transmitted to the at least one logic controller.

2. The method of claim 1, comprising maintaining a temperature of the operating environment of the at least one processor around the at least one reference threshold through at least one cooling system, the temperature being the parameter, and the at least one cooling system being the at least one regulation system.

3. The method of claim 1, further comprising obtaining, through a plurality of sensors in conjunction with the at least one of: the processor of the control server and the plurality of processors, the data related to the parameter.

4. The method of claim 1, comprising providing at least one of:
a regulation system one of: local to the each processor of the plurality of processors and global to the plurality of processors as the at least one regulation system, and
a plurality of logic controllers associated with the plurality of processors as the at least one logic controller.

5. The method of claim 2, further comprising at least one of:
providing information associated with an extent of temperature regulation required along with the at least one control signal; and
pre-defining the at least one reference threshold in a driver component associated with at least one of: the processor of the control server, the plurality of processors, and a plurality of sensors associated with sensing the data related to the parameter.

6. The method of claim 1, comprising providing the at least one logic controller as part of the control server.

7. The method of claim 1, wherein when the analysis of the parameter is performed through the plurality of processors, the method further comprises transmitting status information related to the parameter of the operating environment of the plurality of processors to the processor of the control server based on the analysis.

8. A control server comprising:
a memory; and
a processor communicatively coupled to the memory, the processor being configured to receive data related to a parameter of an operating environment of a plurality of processors, each processor of the plurality of processors being associated with a data processing device of a plurality of data processing devices, the control server being communicatively coupled to the plurality of data processing devices, and, based on the reception of the data related to the parameter, the processor further being configured to execute instructions to:
transmit at least one control signal to at least one logic controller based on comparison of the parameter with at least one reference threshold at least one of: thereat and through the plurality of processors to enable at least one regulation system communicatively coupled to the at least one logic controller maintain the parameter of the operating environment of at least one processor of the plurality of processors around the at least one reference threshold in accordance with the at least one control signal.

9. The control server of claim 8, wherein the at least one control signal is transmitted to enable maintenance of a temperature of the operating environment of the at least one processor around the at least one reference threshold through at least one cooling system, the temperature being the parameter, and the at least one cooling system being the at least one regulation system.

10. The control server of claim 8, wherein the processor is configured to obtain the data related to the parameter through a plurality of sensors in conjunction with the plurality of processors.

11. The control server of claim 9, wherein at least one of:
the at least one control signal comprises information associated with an extent of temperature regulation required, and
the at least one reference threshold is pre-defined in a driver component associated with the processor.

12. The control server of claim 8, further comprising the at least one logic controller.

13. The control server of claim 8, wherein when the comparison of the parameter is performed through the plurality of processors of the plurality of data processing devices, the processor of the control server is configured to receive status information related to the parameter of the operating environment of the plurality of processors therefrom based on the analysis.

14. A system comprising:
a plurality of data processing devices, each data processing device comprising a processor;
at least one logic controller;
a control server communicatively coupled to the plurality of data processing devices, the control server being configured to:
receive data related to a parameter of an operating environment of the plurality of processors, and
transmit at least one control signal to the at least one logic controller based on analysis of the parameter through at least one of: the control server and the plurality of processors, the analysis including comparison of the parameter with at least one reference threshold; and
at least one regulation system communicatively coupled to the at least one logic controller to maintain the parameter of the operating environment of at least one processor of the plurality of processors around the at least one reference threshold in accordance with the at least one control signal transmitted to the at least one logic controller.

15. The system of claim 14, wherein the at least one regulation system is at least one cooling system configured to maintain a temperature of the operating environment of the at least one processor around the at least one reference threshold, the temperature being the parameter.

16. The system of claim 14, further comprising a plurality of sensors associated with the plurality of processors to sense the data related to the parameter in conjunction with the at least one of: the control server and the plurality of processors.

17. The system of claim 14, wherein at least one of:
the at least one regulation system is a regulation system one of: local to each processor of the plurality of processors and global to the plurality of processors, and
the at least one logic controller is a plurality of logic controllers associated with the plurality of processors.

18. The system of claim 15, wherein at least one of:
the at least one control signal comprises information associated with an extent of temperature regulation required, and
the at least one reference threshold is pre-defined in a driver component associated with at least one of: a processor of the control server, the plurality of processors, and a plurality of sensors associated with sensing the data related to the parameter.

19. The system of claim 14, wherein the at least one logic controller is part of the control server.

20. The system of claim 14, wherein when the analysis of the parameter is performed through the plurality of processors, the plurality of processors is configured to transmit status information related to the parameter of the operating environment thereof to the control server based on the analysis.
